(19) United States
(12) Patent Application Publication
(10) Pub. No.: US 2020/0202447 A1
(43) Pub. Date: Jun. 25, 2020

(54) Methods, system, application for household services, wage/compensation loss and visit verification tracking and reimbursement within a multi user integrated system

(71) Applicants: Jewel Lynn Palen, Lansing, MI (US); Charles Day Palen, Lansing, MI (US)

(72) Inventors: Jewel Lynn Palen, Lansing, MI (US); Charles Day Palen, Lansing, MI (US)

(73) Assignee: Discover Claims, LLC, Lansing, MI (US)

(21) Appl. No.: 16/561,157

(22) Filed: Sep. 5, 2019

Related U.S. Application Data
(60) Provisional application No. 62/727,234, filed on Sep. 5, 2018.

(51) Int. Cl. G06Q 40/08; G06Q 20/14

(52) U.S. Cl. CPC G06Q 40/08; G06Q 20/14

(57) ABSTRACT

A system and method are presented using computer code running on multiple devices and server environments preforming bilateral and multilateral network communication enabling the entire process to request reimbursement and issue payment for wage loss and household services including visit verification. Client device applications interact with server API's using persistent storage to allow authenticated account creation in a collaborative environment. Users generate reimbursement requests. Integrated I/O modules collaborate with employers, service providers, and reimbursing entities to process reimbursements and update them through the entire life cycle, which can occur in real-time. Provider visit verification is achieved by combining unique provider identification with time and date information. Reimbursement requests are analyzed and submitted using a digital or physical method based on a plurality of criteria specified by the user and collected metadata. Reimbursing Entities are presented with an integrated work queue that allows them to directly interface with submitted requests.

### SUMMARY

A methodology and system to facilitate all users of the Multi user integrated system/software to recall, store, organize and present functional data, transmit, create, track, modify, compute the value of a claim for reimbursement payment for household services rendered and wage/compensation loss, process claim data for reimbursement payment, verify visits to service providers, and to adjudicate household services and wage/compensation loss data for the purpose of payment in any form including reimbursement through the use of all devices capable of executing the necessary functions to process information and transmit data through digital networks or standard networks.

The methodology and accompanying system or application allows Users to transform inputted and/or collected data into standard formatted data fields for presenting household services data in a defined form for current, past, and future use to request reimbursement payment.

The methodology and accompanying system or application allows Users to transform inputted and/or collected data into standard formatted data fields for presenting wage and compensation loss data in a defined form for current, past, and future use to request reimbursement payment.

The methodology and accompanying system or application allows Users to verify visits to service providers through a combination of inputted and collected data which can be used to request current, past, and future reimbursement payment.

Household services, wage/compensation loss, and reimbursement data is transformed into an electronic form that will be capable of being stored on all devices and machines that are capable of executing the necessary functions to process household services and wage/compensation loss reimbursement claims for insurance claim handling, file management, and compliance.

The system, methodology, and/or application allows Users to access an interactive multi User application solution to interact with Users to collect data needed to create and execute a claim for household services, wage/compensation loss reimbursement payment, and service provider visit verification in addition to managing all related current and historic data.

The methodology presented will facilitate data collection, recall, tracking, and analysis for household services reimbursement payment, which shall include queries, multiple parties interacting with each other through a plurality of designed applications that allow data transmission through networks.

### BRIEF DESCRIPTION OF THE DRAWINGS

FIG. 1 is a high-level diagram representing a possible configuration for the Multi User integrated system/software.

FIG. 2 is an example of options that can be shared between all Users of the invention.

FIG. 3 is an example of options for household services reimbursement requests.

FIG. 4 is an example of options for Users with wage loss reimbursement claims.

FIG. 5 is an example of potential options available for a Reimbursing Entity.

FIG. 6 is a diagram representing possible operations within the Reimbursement Submission Analyzer.

FIG. 7 is a diagram of the Service Provider Visit Verification module.

FIG. 8 is a representation of a Reimbursing Entity Work Queue Example.

FIG. 9 is a representation of a Client Device facilitating the use of the multi User integrated system/software.

FIG. 10 is a depiction of indirect signal input interfacing with a client or directly with server infrastructure.

FIG. 11 is a representation of a single server environment that would facilitate the use of the multi User integrated system/software.

FIG. 12 is an illustration of a scaled-up server computing environment to facilitate a larger number of users.

FIG. 13 is an example of a Household Services submission to a Reimbursing Entity tailored for machine readability.

FIG. 14 is an example of the first part of a possible wage loss submission to a reimbursing entity tailored for machine readability.

FIG. 15 is an example of the second part of a possible wage loss submission to a reimbursing entity where a user can provide evidence proving the loss tailored for machine readability.

FIG. 16 is an example of a submission for a provider visit list for a reimbursing entity tailored for machine readability.

### DETAILED DESCRIPTION

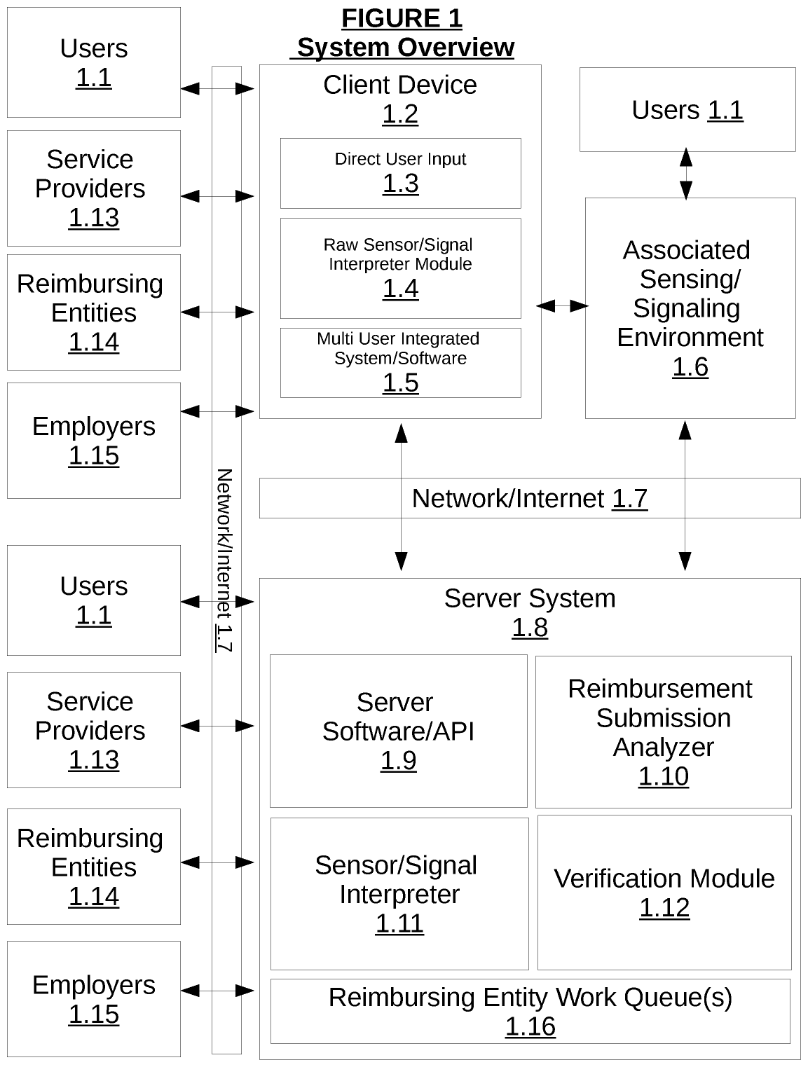

FIG. 1 outlines an integrated system that can operate online or offline to facilitate organization, submission and verification of contractual or government mandated reimbursable expenses between Users 1.1, Service Providers 1.13, Reimbursing Entities 1.14, and Employers 1.15. The multi user integrated system simultaneously and/or separately services one or more users. The design embodies several hardware and software modules that interact to process, organize, distribute, modify, store, and collect data. The Users 1.1, Client Device 1.2, Associated Sensing/Signaling Environment 1.6, Server System 1.8, Service Providers 1.13, Reimbursing Entities 1.14, and Employers 1.15 interact with each other by utilizing the integrated system to allow users to submit household services, wage loss claims, and service providers visit information for reimbursement. A Computer Network or the Internet 1.7 facilitates communication between the various modules of the integrated system.

The Client/User Device 1.2 is meant to represent a personal or public device containing a computing platform, which can include any of the following: phone, tablet, laptop, personal computer, or any other device capable of running a Multi User Integrated System/Software 1.5. The multi integrated system/software shall embody several methods to capture/record data. A common method to capture/record data is direct user input 1.3 using a keyboard, touchscreen, voice commands, or any other technology capable of executing commands. The device may also incorporate sensors that are able to be interpreted by Raw Sensor/Signal Interpreter Module 1.4 for interaction with the single or Multi User Integrated System/Software 1.5.

The Associated Sensing/Signaling Environment 1.6 may be a system within the environment of users 1.1, service providers 1.13, reimbursing entities 1.14, or employers 1.15 that can interact with the invention to preform indirect input on the users 1.1 behalf. This is accomplished by either directly communicating with the Server System 1.8 via the Sensor/Signal Interpreter 1.11 or communicating with a users' 1.1 Client Device 1.2 that can interpret the associated sensing/signaling environment 1.6. Compatible present-day sensing/signaling environments may encompass but not be limited to smart home technologies and control systems.

The Server System 1.8 serves as a computing device or system that may be running on physical computer hardware or virtual machines. It can be within any other configuration that provides an execution environment for computer programs. The environment may have physical connections to output devices such as printers, fax machines, network interfaces, or phone lines. The listing of possible output devices is meant to provide an illustration only, and not limit the potential scope of output devices. The Server System 1.8 runs Server Software/API 1.9, the Reimbursement Submission Analyzer 1.10, the Sensor/Signal Interpreter 1.11, the Verification Module 1.12, and any number of Reimbursing Entity Work Queue(s) 1.16. The Server System 1.8 will also run other support software to facilitate the functioning of these modules such as databases, logging, etc.

The multi integrated system/software allows Users 1.1 to initiate reimbursement requests that can flow through a virtual/digital workflow environment for processing. The reimbursement items are intended to be the result of claims for benefits under an insurance policy, general contract, or government benefit program. The multi integrated system/software allows Service Providers 1.13 to engage with patients to aid in the process of adjudicating reimbursement requests. Service Providers 1.13 will have the capability to complete digital injury reports for the purpose of providing documentation for Users 1.1 reimbursement requests. Service Providers 1.13 can validate appointments, document injuries, provide requested documentation to Reimbursing Entities 1.14 needed to review and approve reimbursement request initiated by Users 1.1 or any party acting on behalf of a User 1.1.

The multi integrated system/software allows Employers 1.15 to engage with Users 1.1, Service Providers 1.13, and Reimbursing Entities 1.14 to validate employment details related to reimbursement requests for wage and compensation loss benefits under an insurance policy, general contract, or government benefit program. The system will evolve over time to add increased functionality for Employers 1.15 validating and providing employment documentation to aid the claims adjudication process on behalf of Users 1.1. The Employer 1.15 may commence a compensation loss reimbursement request by electronic communication directly to the User through the multi integrated system/software.

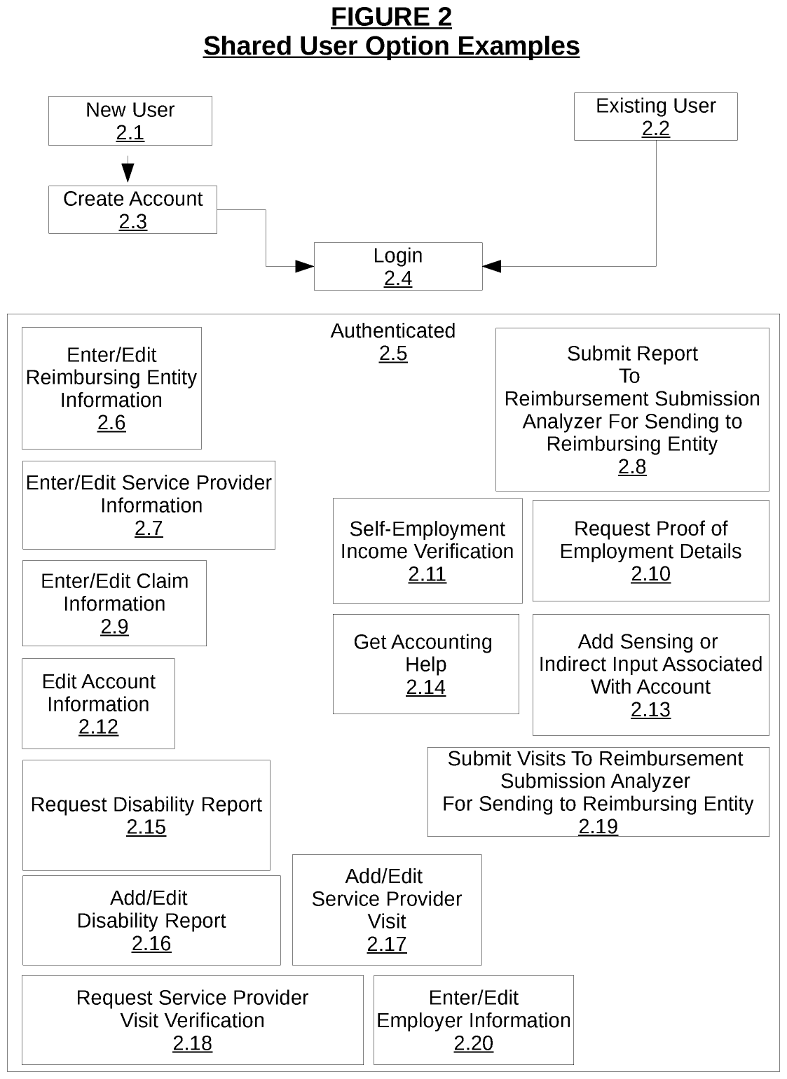

FIG. 2. Shows an example of workflow processes/options within the Multi user integrated system/software 1.5. For brevity, wherever “Edit” is mentioned, edit includes the option to delete items. This is an example and not meant to limit the scope of the options that the system may provide to Users.

A New User 2.1 can Create Account 2.3 if their username has not already been used to create an account within the system. After account creation has been successful, Users can Login 2.4. An Existing User 2.2 can proceed directly to Login 2.4. Details such as E-mail address, company affiliation, or other information may need to be confirmed before Users are allowed to access the system.

Depending on their account type after successful Login 2.4, Users will have access to functionality available while Authenticated 2.5. Authentication will likely be handled by session authentication, but could occur via other technologies such as OAUTH. Authorization Links 6.4 may also provide heightened access to data without undergoing authentication. 2.6 Enter/Edit Reimbursing Entity Information would allow the entry of one or more Reimbursing Entities 1.14.

In order to submit a household services reimbursement, Users will need to Enter/Edit Reimbursing Entity Information 2.6 and Enter/Edit Service Provider Information 2.7. This will allow the entry of one or more Providers. A Provider is a person or entity providing services with an expectation of compensation for services rendered.

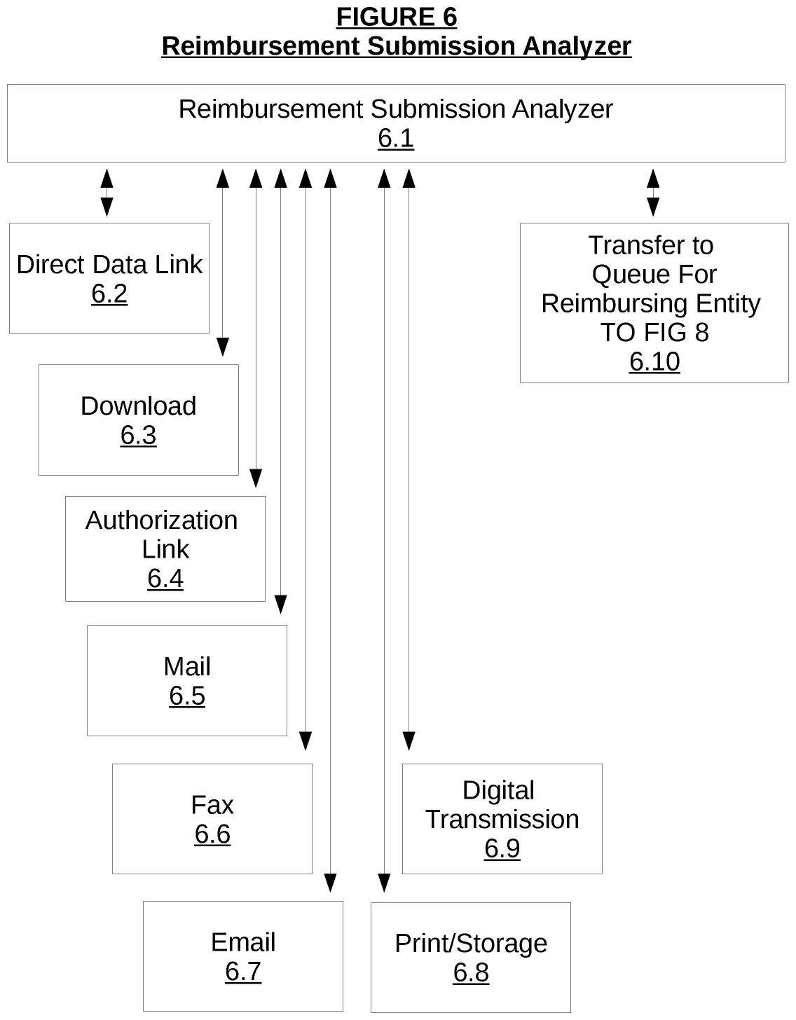

Submit Report to Reimbursement Submission Analyzer for Sending to Reimbursing Entity 2.8 sends a prepared report for reimbursement using the Reimbursement Submission Analyzer as explained in FIG. 6.

Enter/Edit Claim Information 2.9 is the area within the multi user integrated system/software where information is added about the nature/content of the reimbursement request for household services and/or wage loss compensation. Within this module specific household services can be identified and added to a claim for reimbursement. Within this module a user can commence a request for wage loss and compensation benefits.

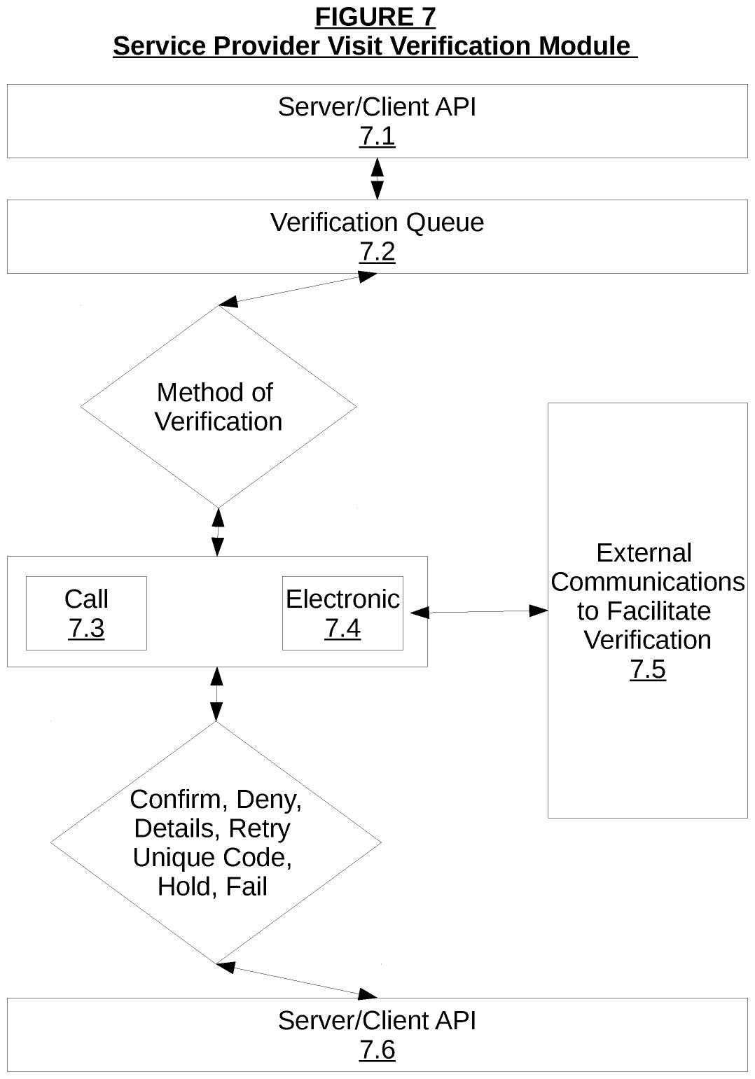

Request Proof of Employment Details 2.10 is an option to allow users to seamlessly utilize the system to request employment related details for the purpose of providing wage and compensation supporting detail. Employers can engage/interact with the system to verify time absent from work. Employers can provide compensation detail through the multi user integrated system/software to expedite wage loss reimbursement. This functionality will use communication methods seen in FIG. 7 and FIG. 6, but may use other methods not explicitly listed.

2.11 Self Employment Income Verification assists self-employed individuals or entities with preparation of a wage loss reimbursement for submission to Reimbursing Entities 1.14. Reimbursing Entities 1.14 have a difficult time processing reimbursement requests for this population as they do not fit the standard mold of Users requesting reimbursement. Processors at a Reimbursing Entity 1.14 are often not trained or knowledgeable on aspects of accounting that would allow them to easily verify self-employment income. Claim Processors at a Reimbursing Entity 1.14 may also not know how to derive a standard bi-weekly paycheck amount from the information provided by a Self-Employed User 1.1. As a Self-Employed User 1.1 this option will allow submission of proof of self-employment income such as Profit and Loss Statements, previous and current year tax returns, Internal Revenue Service transcripts, or other documentation required to substantiate income and compute a compensation loss value. At the Reimbursing Entity 1.14 level, this option will allow workers to request documents needed to substantiate income, as well as show suggested reimbursements for the information provided by a self-employed user.

2.12 Edit Account Information provides Users 1.1, Service Providers 1.13, Reimbursing Entities 1.14, Employers 1.15, and any other Users of the system a way to edit their standard account information.

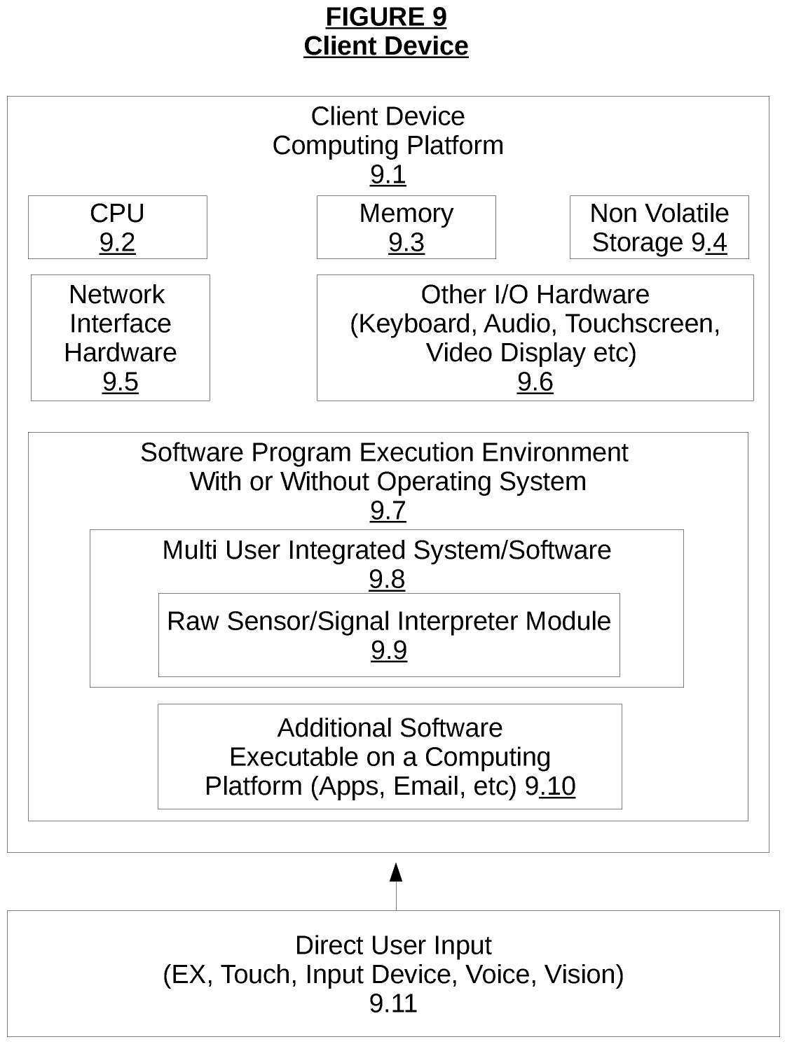

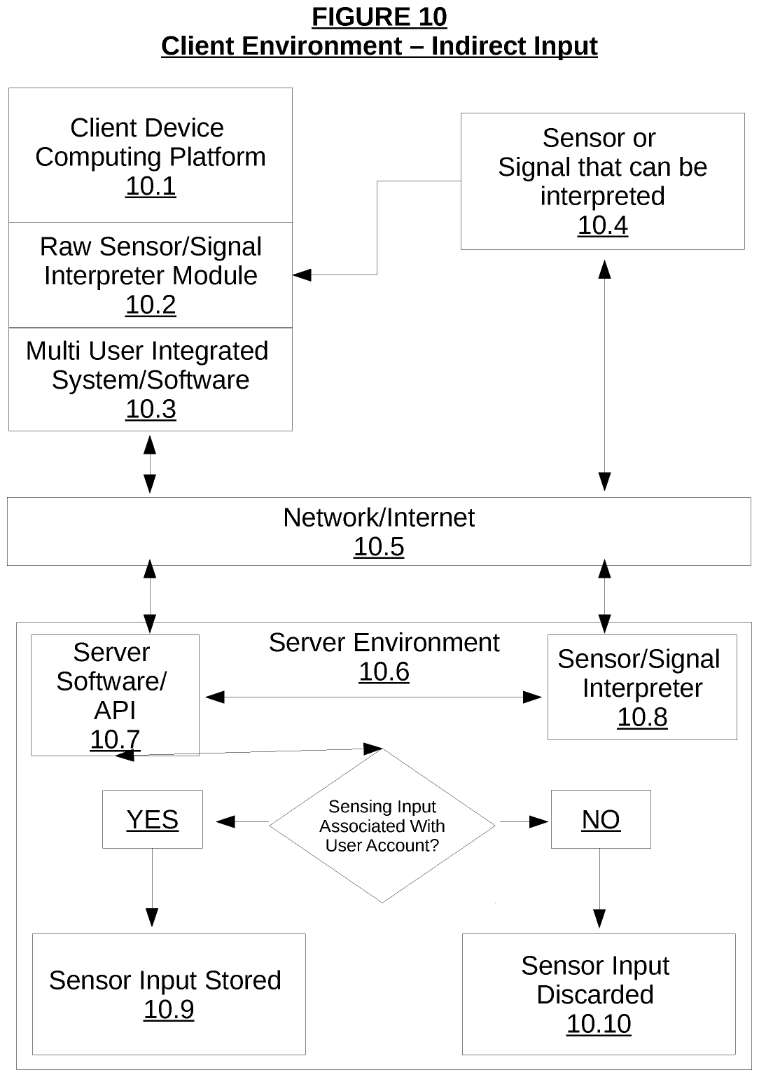

2.13 Add Sensing or Indirect Input Associated with Account allows users of the system to associate a sensing environment with their account as seen in FIG. 1., FIG. 9., and FIG. 10. Users may need to associate a sensing environment by a serial number or other authentication mechanism such as OAUTH.

2.14 Get Accounting Help is a module within the multi user integrated system/software that allows Users 1.1, and a Reimbursing Entity 1.14 to obtain professional accounting help to quantify the value of wage or compensation loss claims for individuals and business owners.

2.15 Request Disability Report represents the action of requesting medical documentation from a Physician to substantiate injury details, plans for treatment, and physical limitations for patients. Disability reports, treatment plans, and any related documentation is used by Reimbursing Entities 1.14 and Employers 1.15 to identify injuries and necessary medical treatment. Through the multi user integrated system/software Service Providers 1.13 can process Disability Reports requests from a work queue by electronically using digital forms contained within the system, or print paper versions of Disability Reports forms that can be mailed, faxed, or uploaded for electronic submission.

2.16 Add/Edit Disability Report provides Users 1.1 a means to supply their own disability report that they have obtained from outside of the functionality of the invention. A user may upload an image or some other digital copy of their disability report to store in the system for later submissions. Users 1.1 can also delete or replace their own provided disability reports.

2.17 Add/Edit Service Provider Visit allows a user to enter details concerning a visit to a service provider. They can then Request Service Provider Visit Verification 2.18. The described process follows a linear path. However, as mentioned in 7.4 there could be Electronic means of visit verification in place that a user may take advantage of. If the user participated in visit verification as seen in FIG. 7. prior to entering a Service Provider Visit 2.17; the invention could automatically pull the service provider information using the one time key prefix associated with each service provider described in 7.4. This would provide the user with a validated service provider visit without having to enter any of the information in manually.

2.18 Request Service Provider Visit Verification provides an option for Users 1.1, Reimbursing Entities 1.14, or Employers 1.15 to request verification of a service provider visit. This functionality is illustrated in FIG. 7. and may be performed in a variety of ways. Users 1.1 may have already used one of the methodologies mentioned previously to verify the visit; but a Reimbursing Entity 1.14 or Employer 1.15 may still wish to verify a visit.

2.19 Submit Visits To Reimbursement Submission Analyzer For Sending to Reimbursing Entity would allow Users 1.1, Service Providers 1.13, and Employers 1.15 to submit verified or unverified logs of visits to a Reimbursing Entity 1.14 though the Reimbursement Submission Analyzer, FIG. 6.

2.20 Enter/Edit Employer Information may allow Users 1.1, Service Providers 1.13, Reimbursing Entities 1.14, or Employers 1.15 to enter employer information. This can be beneficial on several levels within the system. For example, within the scenario of wage loss, a User 1.1 may wish to request a disability report from their Employer 1.15. With employer information already in place, the User 1.1 can easily request this information from their employer as well as any other documentation that may be required. In an example of an Employer 1.15 using the system, they may wish to interface with a Reimbursing Entity 1.14 to facilitate information exchange regarding a disability. With this information present in the system, it would allow seamless communication between the two parties.

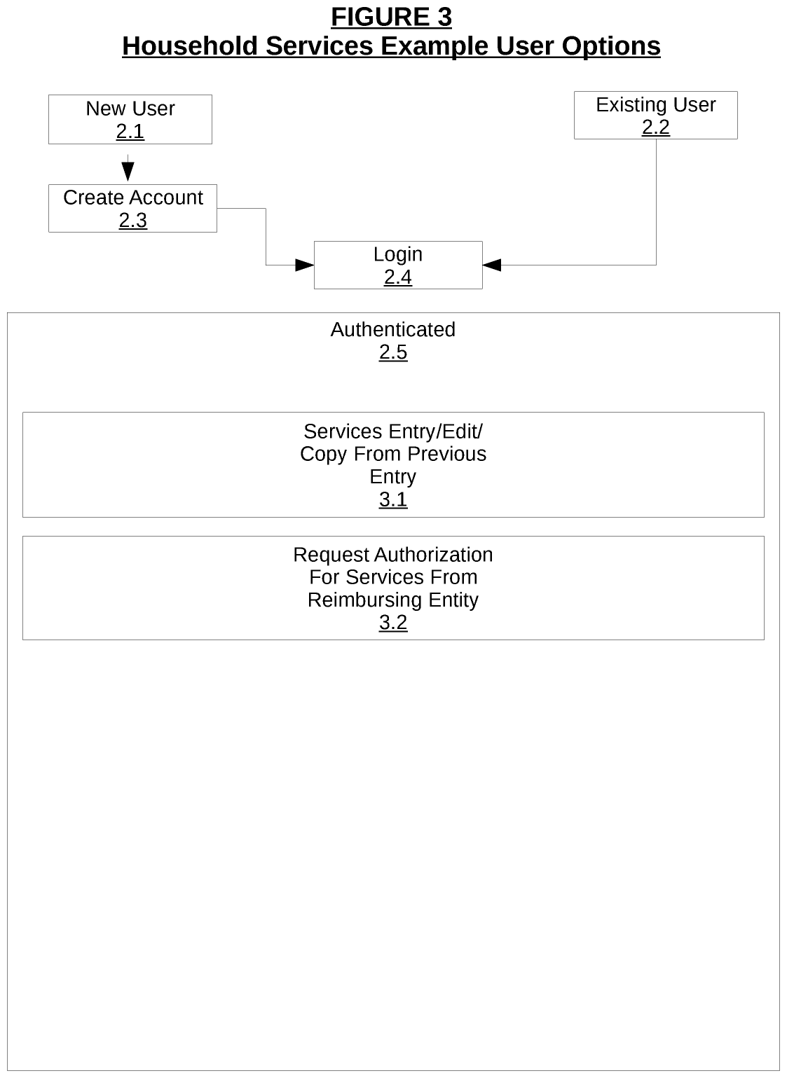

FIG. 3. is a demonstration of potential workflow options that a User interested in Household Services claims for reimbursement would experience within the invention along with all of the options in FIG. 2. These examples are for demonstration and not meant to limit the possible options available within the invention. For brevity, wherever “Edit” is mentioned, edit includes the option to delete items. FIG. 3. may be from the perspective of several types of Users. For example, FIG. 3. may be from the perspective of a User 1.1 that is having services performed on their behalf. FIG. 3. could also be a User 1.1 or Service Provider 1.13 who are providing services for a patient. These use case scenarios are meant to shed light on possible uses of the invention, but not limit the scenarios in which it can be used. The numbering in this section is for reference only. It is not meant to imply that these operations must be performed in any particular order.

2.1-2.5 are shown again only for illustration. You can find the description for these items in FIG. 2.

3.1 Services Entry/Edit/Copy from Previous Entry is where the actual services preformed within a reimbursement period are entered into the system. These entries may be inserted one by one, may be copied from a previous entry, or could be generated by Indirect Input (FIG. 10).

3.2 Request Authorization for Services from Reimbursing Entity provides an option for users of the system to attempt to request authorization for services before they are preformed or submitted for reimbursement. This authorization attempt would use the same methods of communication shown in FIG. 6. and FIG. 7. Much of the reimbursement methodology after services are already preformed creates an inefficient system for Service Providers 1.13, Reimbursing Entities 1.14, Employers 1.15, and Users 1.1. Reimbursement as a whole in the medical industry is a complete disaster. It leaves Users 1.1, Service Providers 1.13, Reimbursing Entities 1.14, and Employers 1.15 in the dark about a service preformed until after it has already been performed. After a service has been performed, Users 1.1 never know how much they will end up being charged or how much a Reimbursing Entity 1.14 will cover. Reimbursing Entities 1.14 never know how much a Service Provider 1.13 will attempt to charge and have to use market share clout to force an agreeable amount they will reimburse a Service Provider 1.13. The reimbursement system is not ideal for anyone involved. This option of the system attempts to allow Users 1.1, Service Providers 1.13, and Employers 1.15 to request an advance authorization through the system for services.

After the user has gathered enough information within the system to submit a household services reimbursement request, they may do so via 2.8 Submit Report to Reimbursement Submission Analyzer for Sending to Reimbursing Entity.

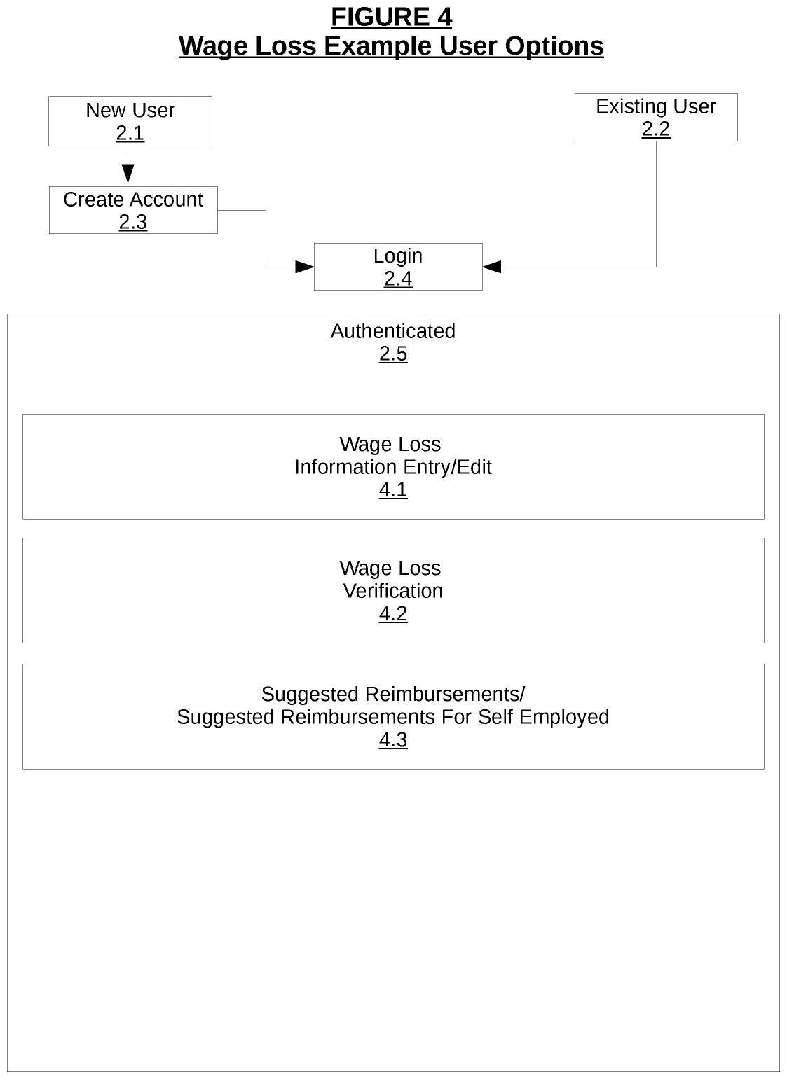

FIG. 4. outlines potential options in addition to FIG. 2. that a user interested in wage loss may have available to them.

2.1-2.5 are shown again only for illustration. You can find the description for these items in FIG. 2.

4.1 Wage Loss Information Entry/Edit may allow users of the invention to enter information and upload data relevant to a wage loss. Examples of information entered that should not be considered an all-inclusive list include:
A. Documents substantiating wage loss.
B. A time period of missed work.
C. Hourly pay or salary at the time of missed work.
D. The normal number of hours worked in a pay period plus any overtime.
E. The number of vacation or sick days used during the time period.
F. A list of additional lost income during the period with enough detail to prove the additional loss.
G. Annual profit and loss statements
H. Previous and current year tax returns or transcripts
I. Any additional information needed to prove the loss
   Users may also wish to edit or delete any of the information that they have entered.

4.2 Wage Loss Verification is a process to assist users of the invention with verification of their wage loss claim. This process may involve contacting Service Providers 1.13, Reimbursing Entities 1.14, Employers 1.15, and any other entity needed to help verify the loss. This process may make use of the verification systems seen in FIG. 6. and FIG. 7. Verification is a crucial step of the entire process for all parties involved. This process may be performed before or after a wage loss reimbursement is submitted.

4.3 Suggested Reimbursements/Suggested Reimbursements for Self Employed may provide Users 1.1, Service Providers 1.13, Reimbursing Entities 1.14, and Employers 1.15 with information about suggested reimbursements based on information within the invention. This feature may be especially important for self-employed individuals. Reimbursing Entities 1.14 often do not have the accounting experience to be able to easily identify reimbursements for self-employed. This functionality will also be helpful for the user wishing to submit a wage loss reimbursement. It may provide that user with some idea of the reimbursement they will receive.

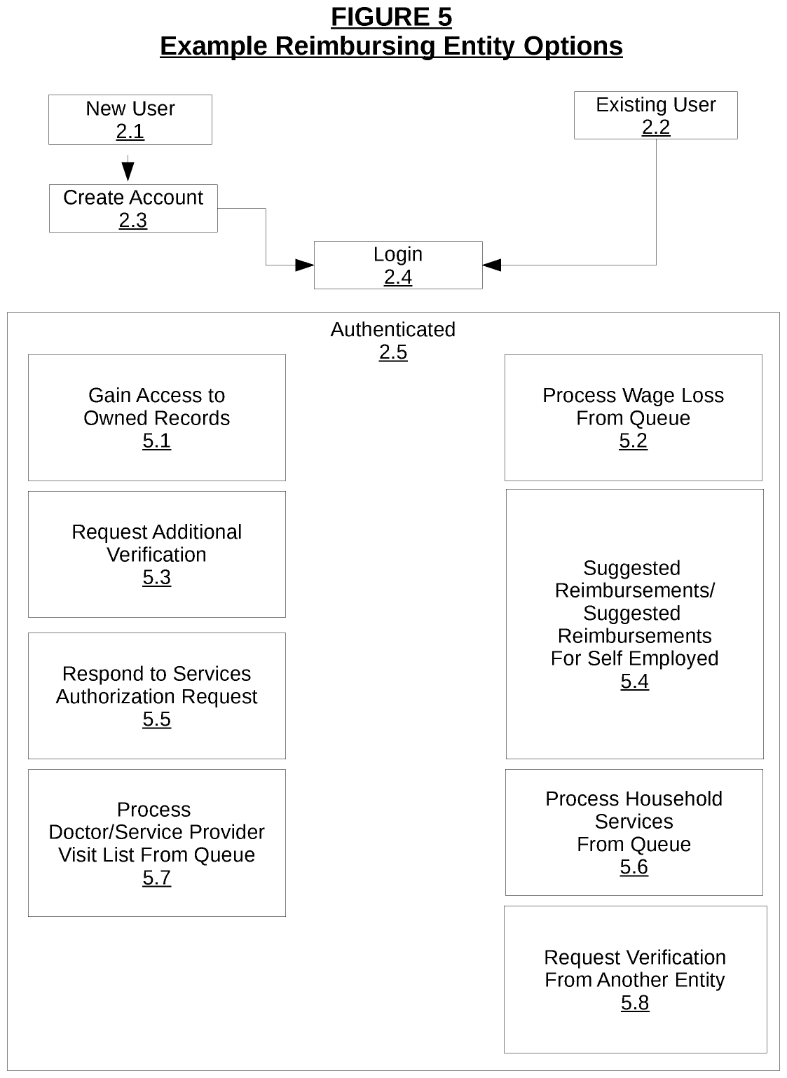

FIG. 5. Example Reimbursing Entity Options shows a potential sampling of options available to a Reimbursing Entity 1.14 though the invention. Although this section specifies a Reimbursing Entity 1.14 there may be use cases where this functionality may be available to other types of users.

2.1-2.5 are shown again only for illustration. You can find the description for these items in FIG. 2.

5.1 Gain Access to Owned Records provides a verified means for users of the system to gain access to records created and owned by other users. Grant of access could be accomplished by a claim number combined with a user's full name, a direct submission to the Reimbursing Entity 1.14 which could provide a special one-time and time sensitive link granting access, or any other means of granting access. It may be helpful for certain users of the system to gain access to other records to help facilitate reimbursement processing, assistance within the invention, or for any other applicable reason.

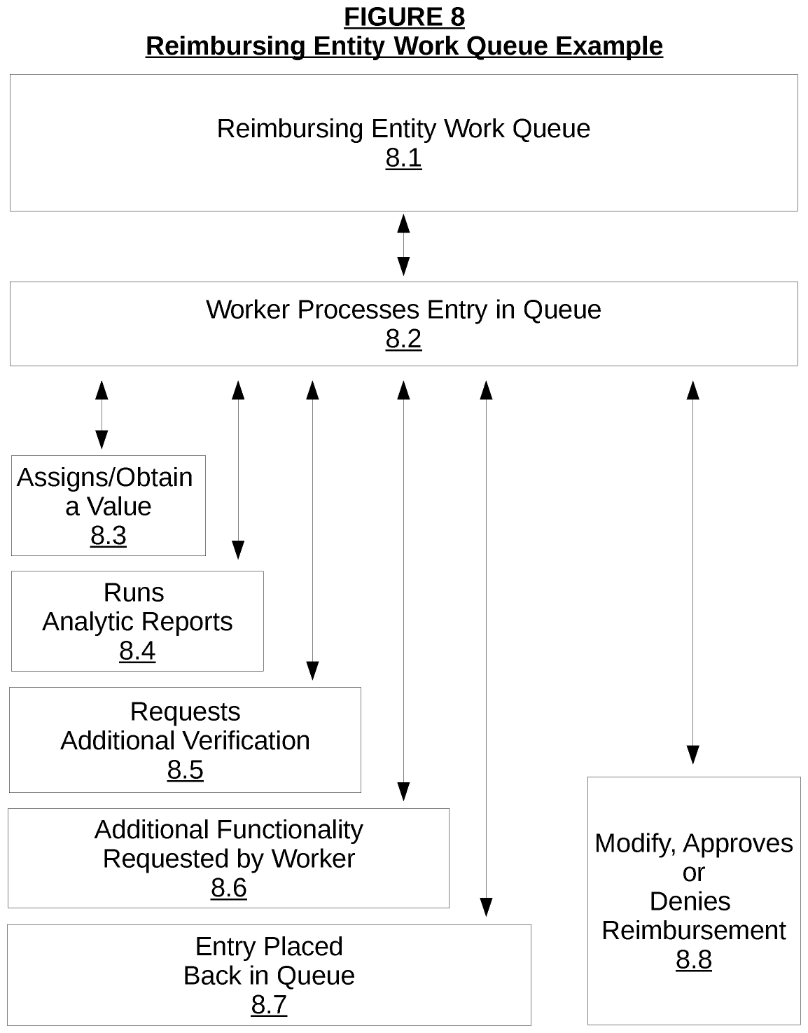

5.2 Process Wage Loss from Queue may allow a Reimbursing Entity 1.14 to pull a submission from their queue and process it. An example of the potential workflow in 5.2 can be seen in FIG. 8. This process may be taking place within the invention or externally at another location. When used within the invention, a Reimbursing Entity 1.14 would gain increased functionality due to the availability of other types of users and their associated data within the system.

5.3 Request Additional Verification may allow a Reimbursing Entity 1.14 to request additional verification for any of the items they are able to process. For example, within a visit verification scenario, a Reimbursing Entity 1.14 may wish to request additional verification of a claimed service provider visit. Also, within a wage loss scenario a Reimbursing Entity 1.14 may wish to request additional verification from Employers 1.14 or Service Providers 1.13. This functionality may use the communication methodology seen in FIG. 6., FIG. 7., or a different means to verify information.

5.4 Suggested Reimbursements/Suggested Reimbursements For Self Employed may provide suggested values to a Reimbursing Entity 1.14 that they can utilize as an extra level of information to base their payable reimbursements on. Reimbursing Entities 1.14 often do not have staff that is familiar with or has the accounting background to easily assess' payments for special circumstances and especially self-employed individuals. This option provides an extra level of information and associated background calculations to assist all parties involved.

5.5 Respond to Services Authorization Request may provide Reimbursing Entities 1.14 a way to examine and respond to requests for services before they are submitted for an actual reimbursement. The entire system of reimbursement after services are provided is very inefficient and difficult for all parties involved. Users 1.1 must often seek treatment or services from Service Providers 1.13 without knowing their total out of pocket expenses. Service Providers 1.13 may also preform services while taking a risk that they may not be fully reimbursed. This methodology provides Users 1.1, Service Providers 1.13, Employers 1.15, and other types of users a means to seek authorization before services are performed.

5.6 Process Household Services from Queue may allow a Reimbursing Entity 1.14 to pull a household services submission from their queue and process it. The potential workflow for this operation can also be seen in FIG. 8. This process could occur completely independently from the invention; but when processed from within the invention there are more tightly coupled means to facilitate communication and data sharing between all parties involved.

5.7 Process Doctor/Service Provider Visit List from Queue may provide a means for a Reimbursing Entity 1.14 to pull a service provider visit reimbursement from their queue and process it. This may occur within the invention or in a completely separate system under management of the Reimbursing Entity 1.14.

5.8 Request Verification from Another Entity may provide functionality for a Reimbursing Entity 1.14 to request their own verification from another entity. The invention provides means to facilitate this verification in FIG. 6. and FIG. 7. Users of the invention may submit already verified details to a Reimbursing Entity 1.14 but that does not preclude the entity from requesting their own verification. There are several example scenarios where verification of claims is needed. In the scenario of a service provider visit reimbursement, a Reimbursing Entity 1.14 may wish to verify all visits to a Service Provider 1.13. In a wage loss scenario verification may be needed from an Employer 1.15 and a Service Provider 1.13. In a household services scenario, verification may be needed from the individual, service provider, or entity actually providing the services. There may be other scenarios not provided as examples where verification could also be helpful. In all scenarios, additional levels of verification for a claim are not only helpful but sometimes necessary.

This section specifically lists Reimbursing Entities 1.14 as the primary user of many of these features. However, scenarios may arise where other users could take advantage of this functionality as well.

The options provided in preceding sections have been for illustration purposes only. They should not in any way limit future options that may be added to the invention. Although FIGS. 2-5 show possible workflow options for different types of users, these options may be available to any users despite their particular use case. The preceding sections have also not meant to preclude the types of users that could perform all of these options. For example, an artificial intelligence could potentially function in any of the major roles described in this system.

FIG. 6. illustrates potential options for the Reimbursement Submission Analyzer 6.1. This is a component that will generally reside within the Server Environment 11.1 of the solution; pieces of it interact with the Client Device Computing Platform 9.1. The Reimbursement Submission Analyzer 6.1 examines requests for reimbursement, and can delay sending out those requests. It can also run out of order. The Reimbursement Submission Analyzer 6.1 looks at the entry time/date stamp, a target submission time/date stamp, the target preferred transmission method, and additional metadata, such as level of security needed to determine how to manipulate and order the queue of reimbursement requests. The highest priority is placed on the target submission time/date stamp. If a reimbursement is to be delivered at a later time/date then other reimbursements without that requirement, it will be processed ahead of the record with a target submission time/date stamp. Records that are submitted ahead of other records without a target submission time/date stamp will be processed as quickly as they can be. Records requiring interaction with the longer running operations, like Mail 6.5 may be held in the queue until they are explicitly released by administrators, Users 1.1, Service Providers 1.13, Reimbursing Entities 1.14, or Employers 1.15.

The Reimbursement Submission Analyzer 6.1 may also be used to facilitate communication between Users 1.1, Service Providers 1.13, Reimbursing Entities 1.14, and Employers 1.15 for non-reimbursement/reimbursement purposes. Examples include but are not limited to; requests from Users 1.1 to Service Providers 1.13 for a disability reports, requests from Users 1.1 to Service Providers 1.13 to verify their service visits, requests from Reimbursing Entities 1.14 to Service Providers 1.13 for a disability report or visit verification, or requests from Users 1.1 to Employers 1.15 for information substantiating a disability report and employment details. This is not an exhaustive list of the possible communication interactions. It is only an illustration that the Reimbursement Submission Analyzer 6.1 is for the purpose of facilitating electronic and non-electronic communications between multiple Users and Non-Users of the Multi user integrated system/software 1.5.

6.2 Direct Data Link is a network/signaling link between the invention and Service Providers 1.13, Reimbursing Entities 1.14, and Employers 1.15. Service Providers 1.13, Reimbursing Entities 1.14, or Employers 1.15 may have internal workflows that they would like the invention to integrate directly with. By providing a Direct Data Link 6.2, the invention is able to submit requests directly to other systems/applications.

6.3 Download option allows Users 1.1, Service Providers 1.13, Reimbursing Entities 1.14, and Employers 1.15 of the invention to download a reimbursement submission or other system communication to their Client Device Computing Platform 9.1.

The Reimbursement Submission Analyzer 6.1 can send a unique Authorization Link 6.4 to Users 1.1, Service Providers 1.13, Reimbursing Entities 1.14, and Employers 1.15. This link will allow the recipient to preform specific operations on the reimbursement submission, and may or may not require authentication. It may allow recipients to confirm or deny the reimbursement through a validation process, or attest the validity of the submission. This link may allow other functionality, but will generally direct Users back into the Multi user integrated system/software 1.5 with special additional data encoded within the link.

Throughout the course of the reporting and reimbursement process, it may be desirable for Users 1.1, Service Providers 1.13, Reimbursing Entities 1.14, and Employers 1.15 to physically Mail 6.5 submissions or verifications. If a Mail option is requested, the system may leave the Reimbursement Submission within a queue until such time that an Administrator can process the reimbursement. The Mail 6.5 functionality may also interface with external services to facilitate the printing and delivery of paper documents related to verification or reimbursement processing.

Users 1.1, Service Providers 1.13, Reimbursing Entities 1.14, and Employers 1.15 can submit information to each other via the system using Facsimile (Fax) 6.6 and/or electronic communications. In order to send a Fax 6.6, the Reimbursement Submission Analyzer 6.1 may use signals to communicate with an external system, or interact with physical devices capable of sending a fax such as a modem.

6.7 Email is an option where applicable for Users 1.1, Service Providers 1.13, Reimbursing Entities 1.14, and Employers 1.15 to submit reimbursements, documentation, or communicate with each other via the multi user integrated system/software 1.5.

6.8 Print/Storage allows Users 1.1, Service Providers 1.13, Reimbursing Entities 1.14, and Employers 1.15 to print communications in the Reimbursement Submission Analyzer 6.1 or store them for later use.

6.9 Digital Transmission will allow any form of submission that allows the traversal of the reimbursement through signals or networks to other systems. This may also include traversal of a reimbursement to non volatile storage for future use.

6.10 Transfer to Queue for Reimbursing Entity is intended to allow the Reimbursement Submission Analyzer 6.1 to transfer one or a plurality of submissions into an external or internal queue that a Reimbursing Entity 1.14 can use to process the submissions. A possible workflow that a Reimbursing Entity 1.14 may encounter when working within this queue can be seen in FIG. 8. It should be noted that use cases may also arise where it may be helpful to transfer one or a plurality of submissions to Users 1.1, Service Providers 1.13, or Employers 1.15 as well as Reimbursing Entities 1.14.

Available communication methods may also be influenced by the types messages being sent between parties. For example, at the time of writing, Fax 6.6 and Mail 6.5 carry greater weight and may have greater financial ramifications for Users 1.1 than Email 6.7 when interfacing with Reimbursing Entities 1.13.

FIG. 7. provides an overview of the Service Provider Visit Verification Module. This module will allow Users 1.1, Reimbursing Entities 1.14, and Employers 1.15 to verify trips to Service Providers 1.13. In this configuration, a verification request flows in through the Client or Server API 7.1. The request is then placed into a Verification Queue 7.2. The Verification Queue 7.2 will examine the Method of Verification requested and may service requests out of order depending on resources available to the system and the method of verification.

The Call 7.3 method of verification may be performed by an automated calling system or a human Administrator. In the case of a human Administrator, the person would take control of the verification within the queue until the verification has completed this step. In the case of an automated calling system, the invention would retain control of the verification within the queue. Options may be presented to Service Providers 1.13 by the Call 7.3 option to:

A. Confirm a visit
B. Deny a visit
C. Provide additional details
D. Request a retry at a later time or date
E. Obtain a unique code associated with the verification so that the Service Provider 1.13 can respond at a later time.
F. Hold until the Service Provider 1.13 can obtain the verification information.
Upon receipt of a Call 7.3, Service Providers 1.13 may not have immediate access to records to confirm or deny a visit. Options D, E, and F above aim to assist Service Providers 1.13 with the time needed to provide an accurate response. These options may be selected from keypad entry, voice input, or any other method applicable to a Call 7.3.

An Electronic 7.4 verification may be carried out by any means available using a computer system. An example scenario of an electronic verification would be a Unique Authorization Link 6.4 sent to a confirmed identity of a Service Provider 1.13. Due to the fact that electronic verification would not need all of the functionality of real-time validation, this link would provide a subset of the options listed above for Call 7.3 verification. Example options could include:

A. Confirm a visit
B. Deny a visit
C. Provide additional details

An Electronic 7.4 verification does not need to include a Unique Authorization Link 6.4, it could simply consist of an Email 6.7 being sent to notify the Service Provider 1.13 that they have a pending visit verification within the system, and prompt them to log into the invention to verify their identity and complete the verification. An Electronic 7.4 verification could also fail after a certain number of attempts due to incorrect contact information for the Service Provider 1.13, technical infrastructure issues, or any other problems preventing the electronic communication. After a failure, or successful response, the result will flow back into the Server/Client API 7.6 and messaging will be provided to the originator of the verification request so that they can take further action depending on the results.

Another example of Electronic 7.4 verification could take place in the setting of an actual Service Providers 1.13 facility. The User 1.1 could request from their Client Device Computing Platform 9.1 (in this case a mobile phone) an Electronic 7.4 verification. This request could flow though External Communication To Facilitate Verification 7.5 to another Client Device Computing Platform 9.1 within the same location as the User 1.1 within the Service Providers 1.13 facility. An embodiment of this Client Device Computing Platform 9.1 could be represented as a peripheral device or a standalone kiosk. If the peripheral device or standalone kiosk implemented a time-based one time unique key functionality that included a static identifier for the Service Provider 1.13; the user could identify and verify their own visit, by entering this uniquely generated key into their own mobile device. The Multi User Integrated System/Software 1.5 on the users mobile device would verify the accuracy of this user entered one time key, or send it to the Server Software/API 1.9 for verification. The invention software would verify the validity of this time-based unique key by performing the same cryptographic operations as the on-site peripheral or kiosk, to not only verify the validity of the identifier associated with the Service Provider 1.13, but also verify that the User 1.1 was actually at the location they claimed to be at the time they claimed to be.

FIG. 8. demonstrates a Reimbursing Entity Work Queue 8.1. This Queue could exist within the Client Device 1.2, Server System 1.8, or a different external system at a Service Provider 1.13 location, Reimbursing Entity 1.14, or Employer 1.15 location. Different systems and methods outside of this invention could also accept reimbursement requests. This queue represents an area where applicable Clients or Users of the system would process submitted reimbursements or communications. The Reimbursing Entity Work Queue 8.1 is where unprocessed reimbursements reside until a system or a Worker Processes an Entry in the Queue 8.2. Reimbursements can flow into a work queue with an expected value, but the system can Assign/Obtain a Value 8.3. It my be desirable to Run Analytic Reports 8.4 against a single or plurality of reports within the Reimbursing Entity Work Queue 8.1. If the reimbursement contains components that have not been verified, such as service provider visits, or wage loss without a disability report, then additional verification could be needed. Requests for Additional Verification 8.5 may integrate with the Service Provider Visit Verification Module, FIG. 7 or utilize another methodology within the system for additional verification. Additional Functionality Requested 8.6 is presented to allow Users of the Reimbursing Entity Work Queue 8.1 to request additional functionality that may be helpful to their specific business needs. Entry Placed Back in Queue 8.7 provides functionality so that an entry that is being processed can be placed back in the Reimbursing Entity Work Queue 8.1. The Processor can use Entry Placed Back in Queue 8.7 to work on a reimbursement request later, or allow someone else to process the entry. Modify, Approves, or Denies Reimbursement 8.8 will allow the User to approve, modify or deny the reimbursement request. Users may also add additional data to the reimbursement request throughout the process. In the scenario where the Reimbursing Entity Work Queue 8.1 is operating as a part of the Multi user integrated system/software 1.5, the approval or denial of the reimbursement would initiate messaging back to other Users of the system to update them on the status of their request.

FIG. 9. provides additional detail about Client/User Device 1.2, which are general computing devices interacting with the Multi user integrated system/software 1.5. The Client Device is meant to represent a general computing device, such as: personal computer, tablet, phone, or any other computer system capable of running the Multi user integrated system/software 1.5. The Client Device Computing Platform 9.1 generally contains a Central Processing Unit (CPU) 9.2, Memory 9.3, Non-Volatile Storage 9.4, Network Interface Hardware 9.5, and other I/O Hardware 9.6 to facilitate User input or data capture capabilities. The Client Device Computing Platform 9.1 should provide a Software Program Execution Environment with or without an Operating System 9.7 that can execute computer code/language and functions to activate the functionality embodied within the Multi User Integrated System/Software 9.8. The Multi User integrated system/software 9.8 may incorporate a Raw Sensor/Signal Interpreter Module 9.9 that can interpret indirect input from the user or environment as meaningful data to be used within the invention to facilitate the reimbursement process.

Additional Software Executable on a Computing Platform 9.10 may also be present on a Client Device Computing Platform 9.1, such as an e-mail client, calendar, maps, local database, network tools, and other software that may support the execution of the Multi User Integrated System/Software 9.8. Additional Software Executable on a Computing Platform 9.10 could also be any arbitrary software of the users choosing. Direct User Input 9.11 should be available on all Client Device Computing Platforms 9.1. Direct User Input 9.11 such as a touchscreen, physical keyboard, mouse, and other input mechanisms allow Users to directly interact with the Multi User Integrated System/Software 9.8.

FIG. 10. presents a client environment with indirect input. Indirect input could occur from a User interacting with a Client Device Computing Platform 10.1. An example of indirect sensing input utilizing only the users' Client Device Computing Platform 10.1 could be achieved in several ways. Utilizing a camera in combination with image recognition, training the Multi User Integrated System/Software 10.3 could classify and identify rooms within a users' home or facility. This could be used to help automatically fill out a work log for household services reimbursement. Another scenario incorporates the use of an accelerometer to dead reckon from a known point within a users' dwelling to also assist with completion of a service log. Another example of how a client device only could be used to facilitate automatic population of service logs incorporates the microphone. Activities could be classified by how they sound. Many devices within our environment have unique sounds. The sounds a dishwasher produces are very distinguishable from a vacuum.

An example of a sensing environment, could be in a smart home where sensors may be placed to detect the presence of a user or service provider within each room. If associated to the user within the system, these sensing activities could be utilized to help automatically generate a service log for Household Services. In the future, it is possible that home service robots could become a routine feature of households and facilities. Utilizing localization information from a robotic platform associated to the user, a service log could also be generated to help automatically populate a Household Service log for reimbursement. These examples were meant to provide an illustration of how sensor input can comprise a portion of the invention, not to limit the scope of possible interactions.

10.1 Client Device Computing Platform can also be seen in FIG. 1. and FIG. 9. It is a representation of a general-purpose computing platform. Raw Sensor/Signal Interpreter Module 10.2 may be an additional module present within the Multi User Integrated System/Software 10.3 to facilitate generation of data within the system.

10.4 Sensor or Signal that can be interpreted is a representation of a signal or sensor within an environment. In the example above utilizing the microphone, 10.4 would represent sound within the environment. Within the context of a smart home/facility scenario 10.4 may represent an actual signal output from a sensor within the environment or Client Device Computing Platform 10.1. A Raw Sensor/Signal Interpreter Module 10.2 in the client and Sensor/Signal Interpreter 10.8 in the Server Environment 10.6 are needed to transform raw sensor data or protocols into actionable items that can be used by the system.

Sensor or Signals that can be interpreted 10.4 may flow directly into the Client Device Computing Platform 10.1 or they could traverse a Network or the Internet 10.5 directly to the Server Environment 10.6. A scenario where direct traversal to the Server Environment 10.6 may be practical could be signals originating from smart home/facilities systems or service robots. A Sensor or Signal that can be interpreted 10.4 may also be detected and interpreted within the Client Device Computing Platform 10.1 and Multi User Integrated System/Software 10.3. From there it can be sent to the Server Environment 10.6 potentially without the need for additional interpretation and flow directly into the Server Software/API 10.7.

10.6 The Server Environment shown here is depicted only as it applies to indirect input. When signals arrive directly from associated sensing platforms, they flow into the Sensor/Signal Interpreter 10.8. This module operates to transform raw signals and differing protocols into actionable items within the system. If the signal or protocol is not recognized by the system, it may be dropped at 10.8. Once signal data has been transformed into meaningful messaging, it can be passed to the Server Software/API 10.7. As signal information flows into the Server Software/API 10.7 it must then undergo a check to determine if it is associated with a user account. If the data can be associated to a user account, interpreted messaging can be stored 10.9 for later use in generating reimbursements. If the data cannot be associated to a user account it will be discarded 10.10.

Indirect sensor data may also flow from the Client Device Computing Platform 10.1 after being interpreted by the Raw Sensor/Signal Interpreter Module 10.2. In this instance, because the device has already interpreted the sensing/signal data it can be transferred from the Multi User Integrated System/Software 10.3 directly to the Server Software/API 10.7 where the determination will need to be made if it is valid and associated to a user account.

For any indirect input, a sensing/signaling environment will need to be associated with a user account within the invention. This could be accomplished in several ways. A potential means of association could be accomplished by the addition of a sensing environment identifier such as a serial number within the invention. With capable environments; known authorization techniques could also be used such as the OAUTH protocol. OAUTH could provide the invention with a unique authorization token pertaining to the sensing environment. Traditional session tokens could also be a way to authenticate and associate incoming sensor data to a user's account. These examples of association are only meant for illustration and not to limit the means by which a sensing/signaling environment may be associated to a user account.

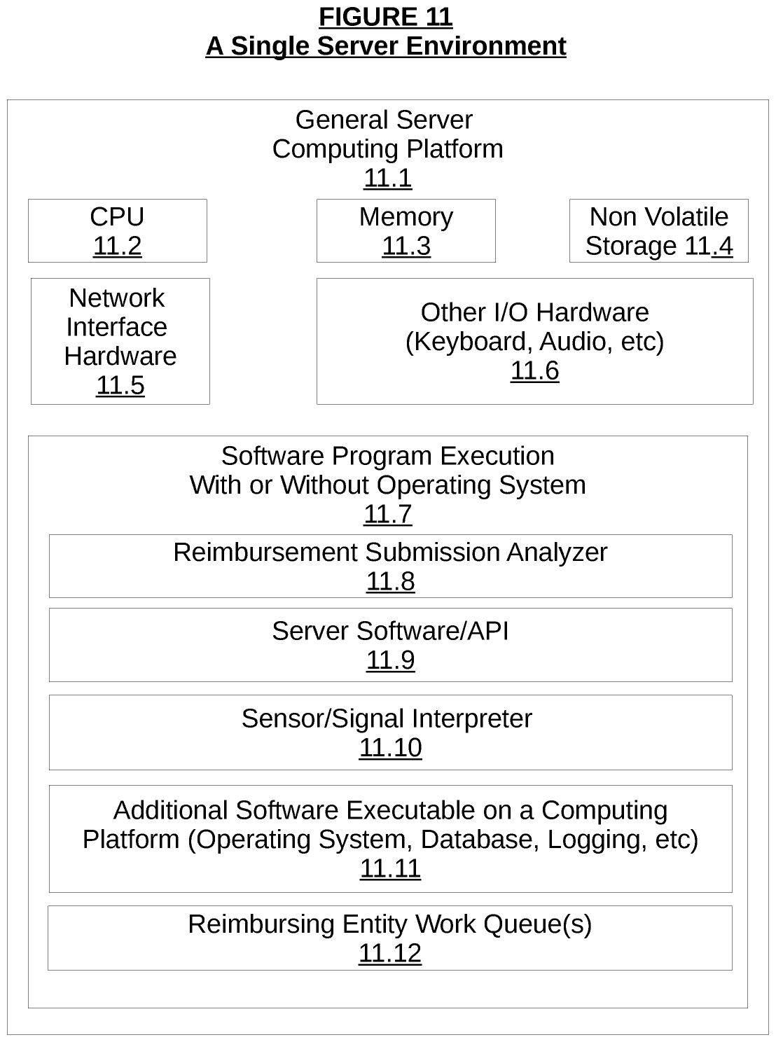

FIG. 11. provides a breakdown of a single server environment. 11.1 illustrates a General Server Computing Platform generally comprising of a Central Processing Unit (CPU) 11.2, Memory 11.3, Non-Volatile Storage 11.4, Network Interface Hardware 11.5, and other input/output (I/O) hardware 11.6. The General Server Computing Platform 11.1 may be comprised of physical computer hardware or could be embodied within a virtual machine; other compatible execution platforms would also suffice. The primary responsibility of the General Server Computing Platform 11.1 is to provide a runtime environment for the Reimbursement Submission Analyzer 11.8, Server Software/API 11.9, Sensor/Signal Interpreter 11.10, Additional Software 11.11, and zero or more Reimbursing Entity Work Queue(s) 11.12. This runtime may be achieved through Software Program Execution With or Without an Operating System 11.7.

The Reimbursement Submission Analyzer 11.8 explained in FIG. 6 provides a means of submitting reimbursements. In addition, the Reimbursement Submission Analyzer allows direct or indirect communication with Users 1.1, Service Providers 1.13, Reimbursing Entities 1.14, and Employers 1.15. The Server Software/API 11.9 consists of API functionality for creation, updating, editing, and deletion of records within the invention along with other possible operations. The Sensor/Signal Interpreter 11.10 handles interpretation of sensor and signaling information sent directly to the server environment. Additional Software Executable on a Computing Platform 11.11 may also be present to facilitate the other operations within the system. Examples of potential software include: databases, logging, networking, operating systems, or any other software capable of running on a General Server Computing Platform 11.1 or execution environment. Reimbursing Entity Work Queue(s) 11.12 may be zero or more work queues that Reimbursing Entities 1.14 run within the invention instead of transferring submitted work to an external system for processing. A potential example of a Reimbursing Entity Work Queue 11.12 can be seen in FIG. 8.

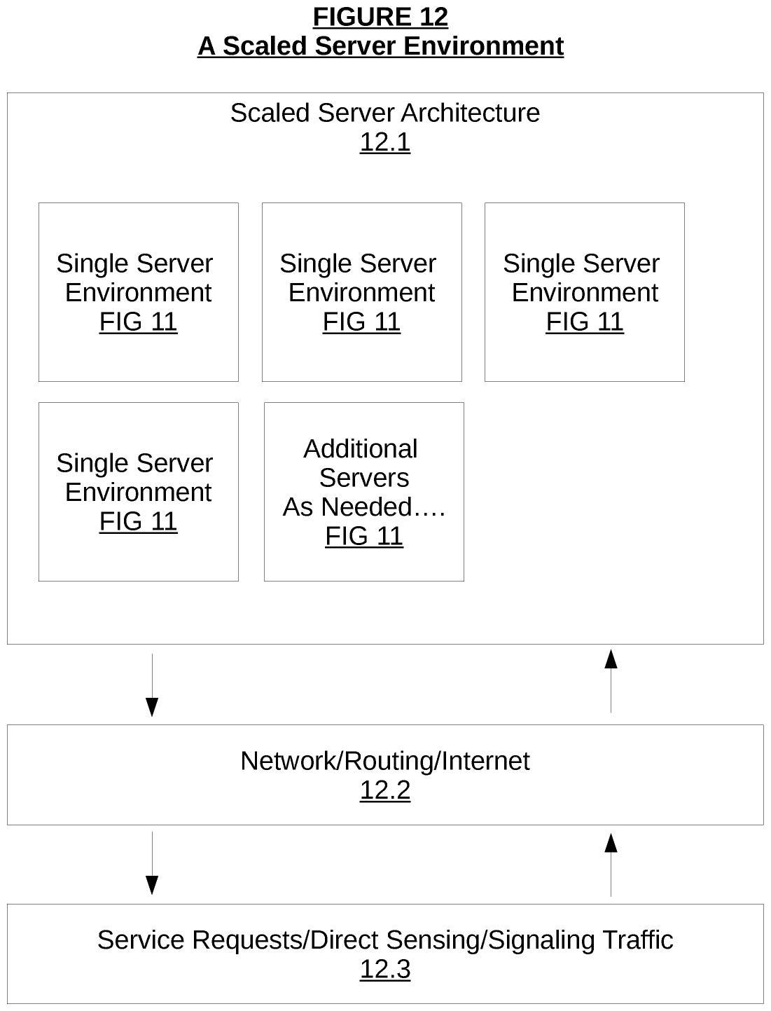

FIG. 12. provides insight into what a scaled server environment might look like to accommodate an increased number of simultaneous Users. A Scaled Server Architecture 12.1 may include several duplicates or variations of the Single Server Environment from FIG. 11 undergoing load balancing to help distribute requests across General Server Computing Platforms 11.1. Requests for the service and signals will flow in and out of Network/Routing/Internet 12.2. Network/Routing/Internet 12.2 is shown in a compound block but may consist of several separate pieces of networking technology to accomplish signal routing in and out of the system. Service Requests/Direct Sensing/Signaling Traffic 12.3 is another compound block representing all requests or signals going in and out of the service. This may include requests from Users 1.1, Client Devices 1.2, Associated Sensing/Signaling Environments 1.6, Service Providers 1.13, Reimbursing Entities 1.14, and Employers 1.15. Although not shown in the diagram, additional signaling may be flowing in and out of the Scaled Server Architecture 12.1, such as data from the Multi User Integrated System/Software 1.5 or logging or monitoring traffic.

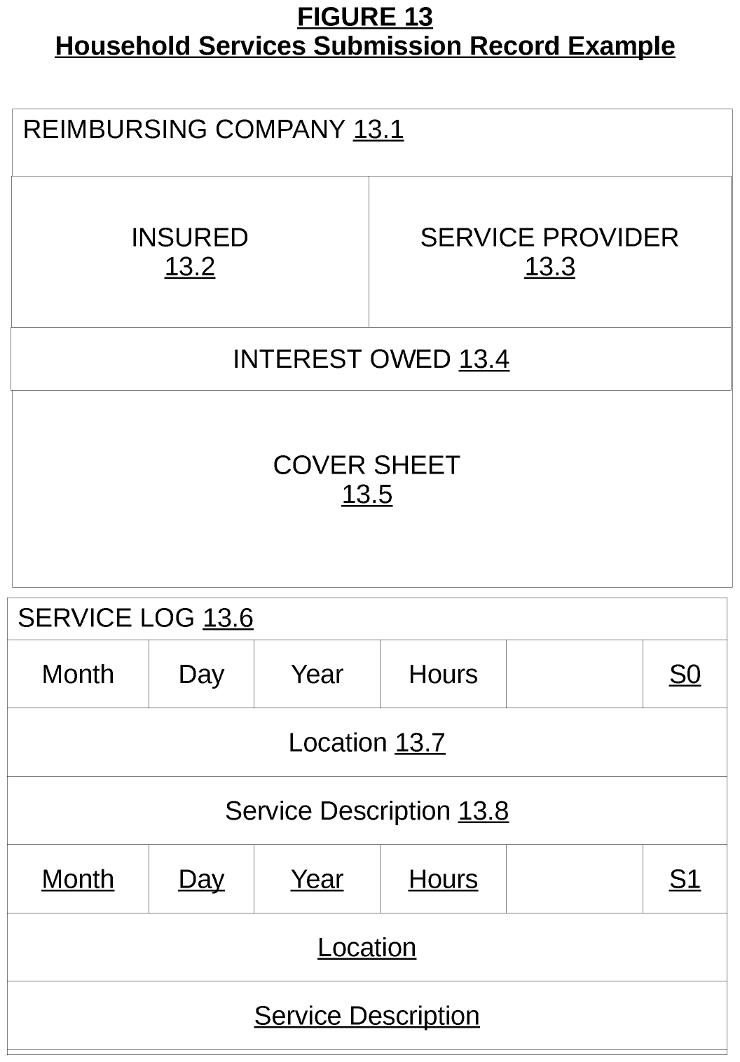

FIG. 13. Household Services Submission Record Example provides an example of what a possible reimbursement submission tailored for machine readability would look like for household services. This submission is generated by the invention and may be delivered in several different ways; some of which were demonstrated in FIG. 6.

13.1 Reimbursing Company would contain all of the pertinent information about the Reimbursing Entity 1.14 such as address and contact information.

13.2 Insured would contain all of the necessary information about the insured party including their claim number and contact information.

13.3 Service Provider contains all of the contact information needed for a service provider.

13.4 Interest Owed may denote an expected value of interest owed for non-payment of an outstanding reimbursement or other scenario that caused interest to accrue.

13.5 Cover Sheet will fill the remainder of the first page with blank space or contain any other pertinent information not described. It may also contain a field that denotes how many service log entries will be submitted with the record.

13.6 Service log will contain uniform entries to facilitate machine readability. These entries will continue until all desired logs have been included in the report. A service log entry contains information about the date that the service was performed as well as the hours it took. A machine-readable identifier seen as S0 and S1, will be present on each service log entry to denote the index of the log.

13.7 Location will be another element within each service log entry. Location will describe where the particular service was performed.

13.8 Service Description will contain a description of the service preformed for each log entry.

Fields have been specifically denoted in FIG. 13. for example, purposes only. They are not meant to limit the type of data that could be submitted with this record.

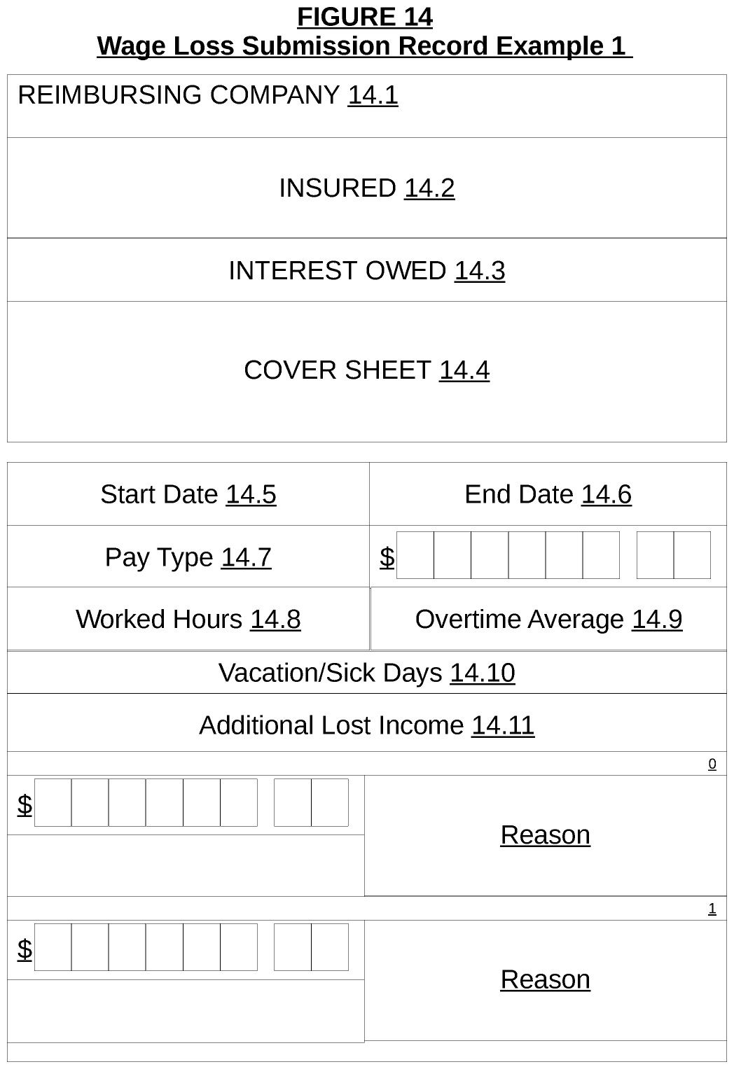

FIG. 14. Wage Loss Submission Record Example 1 is the first page of an example wage loss submission generated by the invention.

14.1 Reimbursing Company contains the contact information for the Reimbursing Entity 1.14.

14.2 Insured contains all of the contact information for the insured or in this case User 1.1. This information may contain a claim number or other important details needed for a submission.

14.3 Interest Owed may contain information about anticipated interest fees associated with the submission.

14.4 Cover Sheet may be an area that could be left blank or filled with other information regarding this submission.

14.5 Start Date will be a representation of the start date of the wage loss period that this submission pertains to.

14.6 End Date will be a representation of the end date of the wage loss period that this submission pertains to.

14.7 Pay Type will describe the type of pay period during the Start Date 14.5 and End Date 14.6. For example, Pay Type may list “Salary” or “Hourly” which will determine the monetary entry to the right of 14.7. In a scenario where 14.7 is filled in as “Hourly”, you may see values such as $57.50. In a scenario where 14.7 is filled in as “Salary”, you may see values such as $30,250.00.

14.8 Worked Hours may contain information regarding the average number of hours worked within a pay period.

14.9 Overtime Average may contain information about the average number of overtime hours that were worked within a pay period.

14.10 Vacation/Sick Days may contain information on the number of vacation or sick days that were used between the Start Date 14.5 and End Date 14.6.

14.11 Additional Lost Income is a section that will contain any number of entries. These entries may contain a dollar amount of the additional lost income, a Reason/description of the lost income, and a machine-readable identifier for the index of the additional lost income. This area constitutes any other income that could have been lost during the period being reported. Examples would include bonuses, special payouts, lost tips, or any other qualifying reason not listed here.

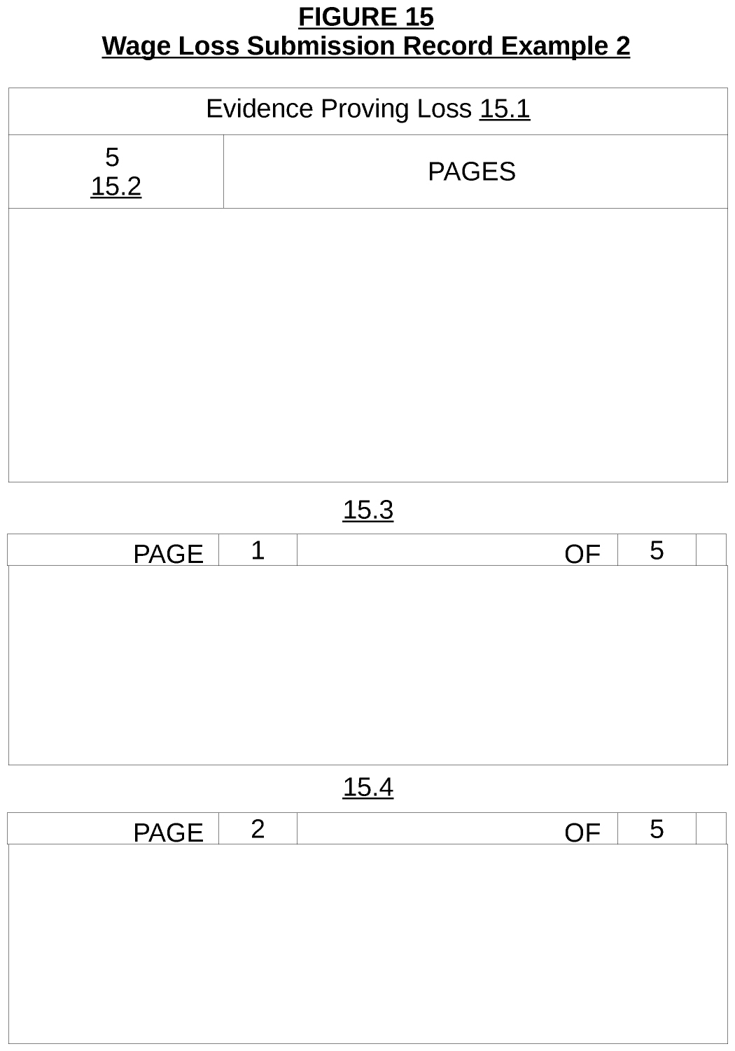

FIG. 15. Wage Loss Submission Record Example 2 is part two of the submission seen in FIG. 14. Along with the information presented in FIG. 14; evidence must also be supplied supporting the loss of income. This section allows the submission of any number of documents that prove the loss claimed in FIG. 14. A typical document potentially submitted in this section will be a proof of disability.

15.1 Evidence Proving Loss may be a cover sheet for this section of submissions. It may contain the number of pages that will follow in a machine-readable orientation.

15.2 Shows the number “5” to represent that 5 pages will follow. 15.2 also contains the text representation of “PAGES” but this may or may not be necessary.

15.3 Shows an example entry of another page. The number of the page is represented in a uniform location that will facilitate machine readability. In this example, the number of the page is shown as “1”. On the same line, it also identifies the total number of pages, seen here as “OF 5”. Although the area below the described page identifiers are blank in this example; in reality they may contain images, text, or data. The blank area will contain supporting information evidencing the loss or additional information for the submission.

15.4 Shows an identical entry to 15.3 except for the page number identification line. In this case represented by “PAGE 2 OF 5”. Although the space underneath the page identifier is again blank, in reality it will contain images, text, or data providing additional information for the submission.

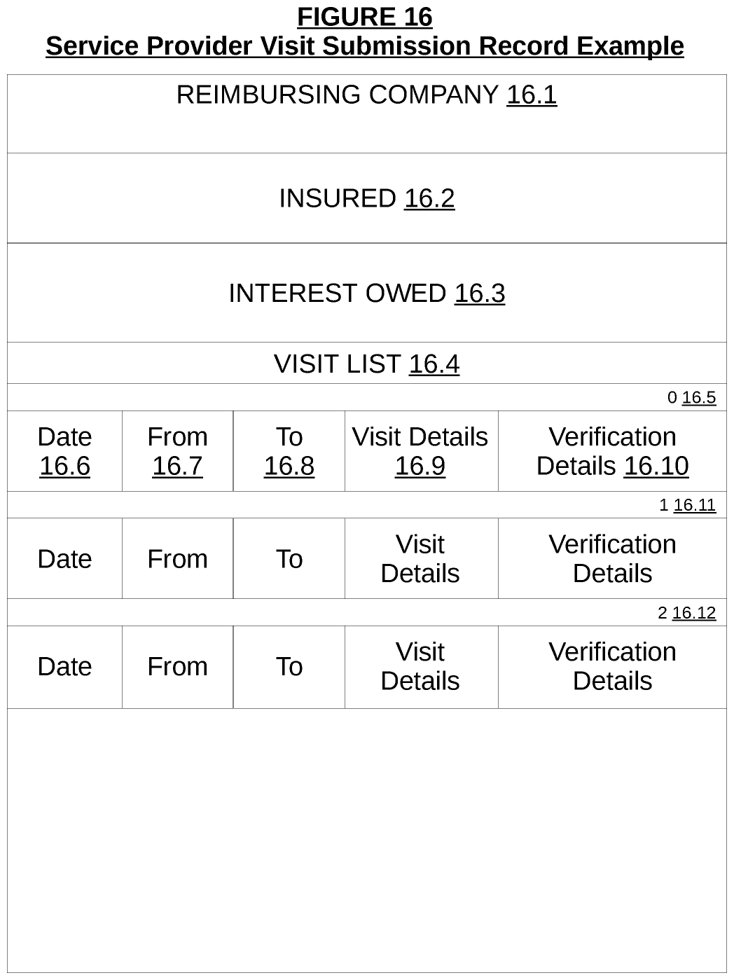

FIG. 16. Service Provider Visit Submission Record Example demonstrates an example of a possible submission of a user utilizing the visit verification functionality.

16.1 Reimbursing Company will contain all of the important information about the Reimbursing Entity 1.14 that the record is being submitted to. This may contain contact or mailing data among other information.

16.2 Insured lists the details of the party submitting the record. This information may contain contact details, a claim number, and any other pertinent information to submit the record.

16.3 Interest Owed may contain a value of claimed interest owed related to the record submission.

16.4 Visit List is a list of indefinite length that lists all of the visits that are included in this submission. The visits may be verified or unverified at the time of submission.

16.5 “0” is an index representation of the visit list record in the line below it. This index is incorporated for labeling as well as facilitating machine readability.

16.6 Date is an entry in a visit list item. It may specify the date on which the visit took place.

16.7 From is an entry in a visit list item. It may specify where the visit originated from.

16.8 To is an entry in a visit list item. It may specify where the visit occurred at.

16.9 Visit Details may contain any additional information about the details of the visit needed for the record submission.

16.10 Verification Details may contain information about the verification of the visit.

16.11 Is another line representing an example of an additional visit list item within the submission.

16.12 Is another line representing an example of an additional visit line item within the submission.

FIG. 16. shows an example visit submission with three visits. These visits may be to the same or different providers at different locations. This submission could span multiple pages including one or more visits.

1. The invention claimed is a computer implemented method carried out by a computer system/program containing computer language with instructions for functionality related to modules that allow multiple users to access the functionality in order to facilitate the entire process needed to request reimbursement and issue payment for contractual benefits for wage loss, and household (custodial care) services consisting of:
one or more internet accessible servers including a processor, memory, non-volatile storage, and input/output devices capable of execution of the necessary computer code for system functionality and to facilitate communications over networks;
transmission of computer code and data to personal computing devices including a processor, memory, storage, and input/output devices capable of executing the necessary computer code to allow bilateral and multilateral communication between said internet accessible server(s) and personal computing device(s) as well as rendering of a user interface when policy holders, insureds, claimants, service providers, insurance companies, employers, and representatives of those mentioned interact with the said internet accessible server(s) using a personal computing device;
allowing any user to access an interactive self-service-based computer program/application to execute requests for wage loss and household (custodial) care service reimbursements, as opposed to only allowing access to specific users.

2. The computer-implemented method of claim 1 wherein any user may create accounts within a system or access the system without an account to request reimbursement payments related to contractual obligations owed for wage loss and household (custodial care) services.

3. The computer-implemented method of claim 1 wherein wage loss and household (custodial care) services details are inputted/captured, compiled, organized into standardized forms/records, and assigned a monetary value.

4. The computer-implemented method of claim 1 wherein users can access standardized forms tailored for machine readability that can be digitally or physically submitted for wage loss and household (custodial care) services reimbursement.

5. The computer-implemented method of claim 1 wherein any system user can transmit requests for wage loss and household (custodial care) services to an entity for payment processing.

6. The computer-implemented method of claim 1 wherein payment processing for wage loss and household (custodial care) services reimbursement requests are monitored for contractual and/or regulatory compliance and full payment for any user, as opposed to the current standard of segmentation that disconnects users and thus serves the self-interest of the user that acquired the system.

7. The computer-implemented method of claim 1 wherein any user can manage all current and/or historic wage loss and household (custodial care) services reimbursement data for the perpetual or limited life of the user.

8. The computer-implemented method of claim 1 wherein users can manage requests for wage loss and household (custodial care) service reimbursements for various insurance companies and policies simultaneously.

9. The computer-implemented method of claim 1 wherein any user can access functionality to facilitate medical related visit/appointment verification.

10. The computer-implemented method of claim 1 wherein a Reimbursing Entity can process for payment household services or wage loss reimbursement requests from within the said self-service-based computer program/application.

11. The computer-implemented method of claim 1 wherein environmental sensing technology may assist with data collection and form completion for reimbursement requests for household (custodial care) services.

12. The computer-implemented method of claim 1 wherein the invention/system could function as a standalone system or a part within any claims adjudication system that contains modules and functionality to process reimbursement information.

13. The invention claimed is a computer-implemented method with capabilities to operate as a part within a multi-functional claims processing system to facilitate the reimbursement request and payment of wage loss claims for users with self-employment income consisting of:
one or more internet accessible servers including a processor, memory, non-volatile storage, and input/output devices capable of execution of the necessary computer code for system functionality and to facilitate communications over networks;
transmission of computer code and data to personal computing devices including a processor, memory, storage, and input/output devices capable of executing the necessary computer code to allow bilateral and multilateral communication between said internet accessible server(s) and personal computing device(s) as well as rendering of a user interface when policy holders, insureds, claimants, service providers, insurance companies, employers, and representatives of those mentioned interact with the said internet accessible server(s) using a personal computing device.

14. The computer-implemented method of claim 13 wherein Users and Reimbursing Entities are able to work collaboratively within the invention/system to execute all required tasks and documentation needed to initiate and resolve reimbursement requests for income loss benefits.

15. The computer-implemented method of claim 13 wherein payment processing for income loss reimbursement requests are monitored for contractual and/or regulatory compliance and full payment for any user, as opposed to the current standard of segmentation that disconnects users, and thus serves the self-interest of the user that acquired the system/application.

16. The computer-implemented method of claim 13 wherein Users can add or use existing claim and insurance information to populate data fields for income loss reimbursement requests.

17. The computer-implemented method of claim 13 wherein a self-employed user may receive personalized suggestions about how much compensation they should be entitled to for income loss reimbursements based on submitted information and contractual terms.

18. The computer-implemented method of claim 13 wherein a Reimbursing Entity is offered suggested reimbursement values for self-employed income loss claimants based on submitted information/documentation.

19. The computer-implemented method of claim 13 wherein Reimbursing Entities and/or self-employed users are presented options to get accounting help within the invention.

20. The computer-implemented method of claim 13 wherein any user can manage all current and/or historic income loss data for the perpetual or limited life of the user.

21. The invention claimed is a computer-implemented method with capabilities to operate as a part of a multi-functional claims processing system for visit verification as it applies to reimbursements for contractual benefits related to wage loss, compensation loss, household services, medical mileage, and transportation consisting of:
one or more internet accessible servers including a processor, memory, non-volatile storage, and input/output devices capable of execution of the necessary computer code for system functionality and to facilitate communications over networks;
transmission of computer code and data to personal computing devices including a processor, memory, storage, and input/output devices capable of executing the necessary computer code to allow bilateral and multilateral communication between said internet accessible server(s) and personal computing device(s) as well as rendering of a user interface when policy holders, insureds, claimants, service providers, insurance companies, employers and representatives of those mentioned interact with the said internet accessible server(s) using a personal computing device;
the computing device being able to capture/receive a unique time-based verification code generated for a service provider's location to facilitate appointment verification.

22. The computer-implemented method of claim 21 wherein a unique provider identification will be generated and linked to a service provider's physical address.

23. The computer-implemented method of claim 21 wherein the said provider unique identification in conjunction with current time and date information allows for the creation of a unique location code that can be provided to a user upon request.

24. The computer-implemented method of claim 21 wherein the unique location code is inputted in a client device, transmitted to a client device, or captured by a client device, which is then transmitted to the server environment along with the asserted appointment/visit date, time, and location information.

25. The computer-implemented method of claim 21 wherein visit verification can occur within the invention by use of computer code designed to access provider identification details and unique location codes to check for actions taken by medical providers to confirm visits and to check data within the server environment that would conflict with information provided by the user.

26. The computer-implemented method of claim 21 wherein verified medical visits/appointment data transmitted by a user is available on a server and accessible to Reimbursing Entities and third parties for review and additional validation, which can occur in real time.

27. The computer-implemented method of claim 21 wherein the visit verification system could function as a standalone system or a part within a claims adjudication system that contain modules and functionality to process reimbursement information.
